(19) United States
(12) Patent Application Publication
(10) Pub. No.: US 2026/0368956 A1
(43) Pub. Date: Nov. 19, 2026

(54) STYLIZED STRUCTURAL PATTERNS FOR GENERATION OF SYNTHETIC IMAGES

(71) Applicants: Disney Enterprises, Inc., Burbank, CA (US); ETH Zürich (Eidgenössische Technische Hochschule Zürich), Zürich (CH)

(72) Inventors: Farnood Salehi, Zurich (CH); Tunc Ozan Aydin, Zürich (CH); Vandit Sharma, Zürich (CH)

(73) Assignees: Disney Enterprises, Inc., Burbank, CA (US); ETH Zürich (Eidgenössische Technische Hochschule Zürich), Zürich (CH)

(21) Appl. No.: 19/212,450

(22) Filed: May 19, 2025

(51) Int. Cl. G06T 11/10; G06V 10/774; G06V 10/82

(52) U.S. Cl. CPC G06T 11/10; G06V 10/774; G06V 10/82

(57) ABSTRACT

In some embodiments, a method initializes parameters of a network. A plurality of points is sampled on a grid of a plurality of pixels. For a set of iterations for each point, the method inputs an input value for a point in the plurality of points into the network to determine an output value based on the parameters of the network; computes a next input value for the point based on the output of the network and a position of the point; and recursively inputs next input values for the point into the network to generate a set of input values. The input values for the point are compared to a threshold to determine a comparison result. The method uses the comparison result for the plurality of points to determine pixel values for pixels in the plurality of pixels, wherein the pixel values are used to generate a synthetic image.

### BACKGROUND

Most computer vision models have relied heavily on extensive collections of real-world image data for training purposes. However, as model architectures continue to grow in complexity and achieve superior performance, the demand for larger datasets has increased, posing substantial challenges and costs associated with data collection efforts. The curation process of these datasets often raises concerns related to privacy, licensing, and ethics, making them unsuitable for production environments.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a system for generating neural fractals for training models according to some embodiments.

FIG. 2 depicts an example of neural fractal generation system according to some embodiments.

FIG. 3 depicts a flowchart of a method for neural fractal generation according to some embodiments.

FIG. 4 depicts a flowchart of a method for adding points to a fractal set according to some embodiments.

FIG. 5 depicts a flowchart for generating neural fractals using escape time coloring and adaptive sampling according to some embodiments.

FIG. 6 depicts a flowchart of a method for performing reverse stylization according to some embodiments.

FIG. 7 illustrates one example of a computing device according to some embodiments.

### DETAILED DESCRIPTION

Described herein are techniques for an image generation system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system uses a two-step approach to generate high-quality synthetic data for training neural networks, such as in computer vision tasks. The first step involves generating a base synthetic dataset using neural fractals. The neural fractals may be synthetic data where fractals are derived from dynamical systems based on complex-valued neural networks. The neural fractals may improve synthetic datasets, which improves the training on computer vision models.

The second step involves stylizing the base synthetic dataset using reverse-stylization, which transfers visual features from a sample of real images to synthetic images. This approach enables the creation of synthetic images with visual features that resemble real images, effectively bridging the domain gap between real data and synthetic data. Notably, a smaller dataset of real images may be sufficient to reverse-stylize a significantly larger synthetic dataset, resulting in improvements in training of models.

The combination of neural fractals and reverse-stylization improves the generation of high-quality synthetic data, which can be used to train neural networks for a wide variety of tasks, such as computer vision tasks. By leveraging the strengths of both approaches, the system creates synthetic data that is comparable to real-world data in terms of quality and diversity, thereby addressing the long-standing challenge of domain gap between real data and synthetic data.

### System

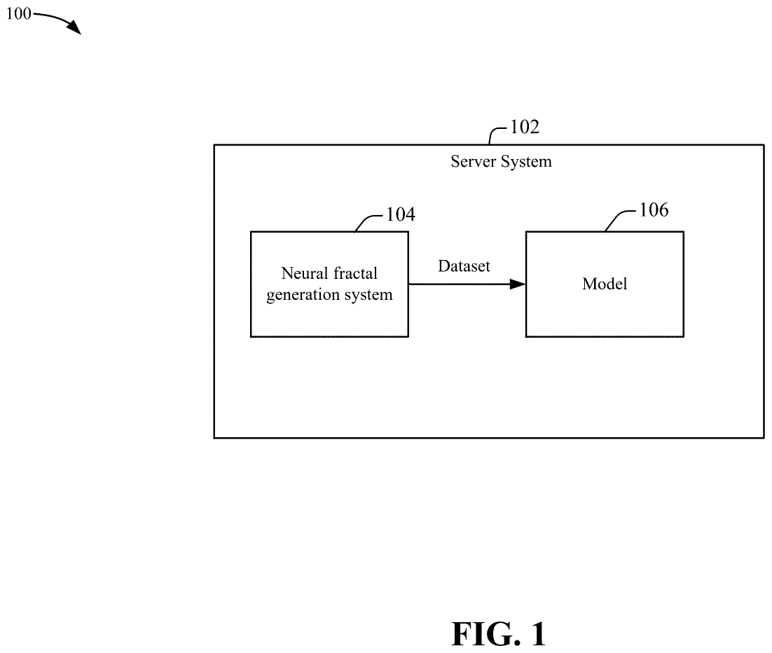

FIG. 1 depicts a system 100 for generating neural fractals for training models according to some embodiments. Server system 102 includes a neural fractal generation system 104 and a model 106.

Neural fractal generation system 104 includes a neural network that is used to generate synthetic data (e.g., synthetic images). The synthetic images are generated based on neural fractals. Neural fractals are generated using complex-valued neural networks to create structural patterns, such as fractal patterns. By coloring pixels differently, patterns are generated. A fractal is a geometric pattern that exhibits self-similarity at different scales, meaning it appears the same or similar at various levels of magnification. Fractals are characterized by their intricate and complex structures, which can be found in nature, such as in snowflakes, tree leaves, and coastlines. The neural networks produce intricate and detailed patterns that can be used as the basis for synthetic datasets. The use of neural networks allows for the creation of complex and nuanced patterns that can mimic the characteristics of real-world data. Neural fractals can be used to generate a wide range of synthetic datasets, each with its own unique characteristics and properties.

Model 106 may be a neural network that receives input and generates an output. Model 106 may be used in different vision tasks, such as analyzing images, generating images, etc. The parameters of model 106 need to be trained to perform its task. Here, the synthetic dataset generated from neural fractal generation system 104 may be used to train model 106. In the training, synthetic images in the synthetic dataset may be labeled and input into model 106. The parameters of model 106 are adjusted based on the output of model 106 and the respective labels of the synthetic images. Different methods of training may be appreciated. Although the synthetic dataset is described as being used to train model 106, the synthetic dataset may be used for other purposes.

The following will describe neural fractal generation system 104 in more detail.

### Neural Fractal Generation System

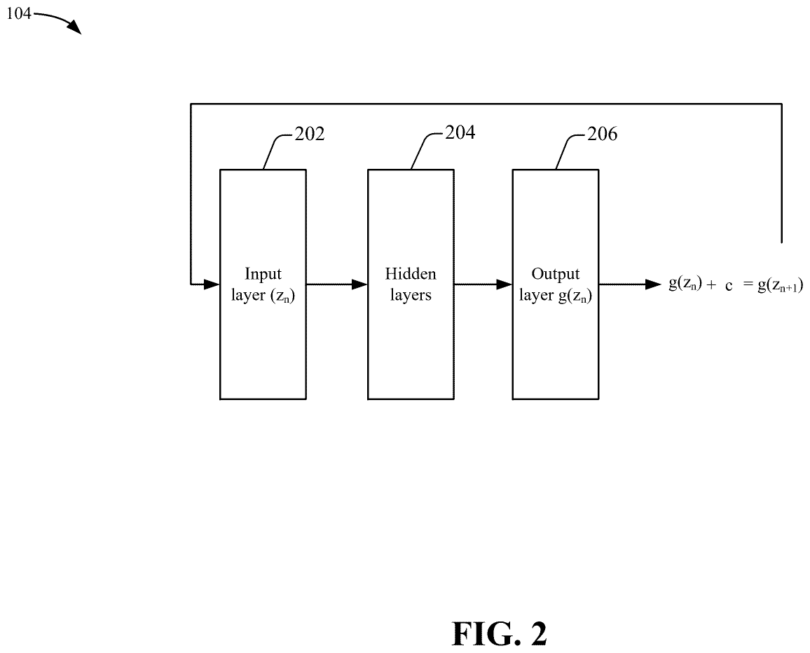

FIG. 2 depicts an example of neural fractal generation system 104 according to some embodiments. Although this neural network is shown, other neural networks may be used. In this embodiment, a fully connected neural network with an input layer 202, hidden layers 204, and an output layer 206 is used. The neural network may start with an input value zₙ and output an output value g(zₙ). The parameters (e.g., weights) of neural network are randomly initialized and represented as a function g. In some embodiments, the values of the parameters may be complex valued and drawn from a normal distribution, which are represented by complex numbers. The next input value may be zₙ₊₁.

The neural fractals may be derived using the following recurrence relation:

zₙ₊₁=g(zₙ)+c, z₀=0,

where c=x+y·jϵC represents a continuous 2D coordinate (x, y) in a grid of the image plane as a complex number, where j is the imaginary unit (√□). The function g(zₙ) may be any real or complex-valued function using a randomly initialized complex-valued neural network g. The process may randomly sample a grid position of a point (x, y). Then, neural fractal generation system 104 iterates through recursion to determine a set of values z for the point. For example, starting with z₀=0, the neural network outputs g(z₀). The output value is based on the randomly initialized parameters of the neural network. The next input value of zₙ₊₁ is based on the output and the coordinate value of the sampled grid position. The next input value of zₙ₊₁ is then recursively input into the neural network to generate g(zₙ₊₁). The next input value of zₙ₊₂ is generated. The process continues for a number of iterations as input values z are recursively input into the network. An epoch may be used where the epoch includes a number of iterations. The result may be a set of input values z (e.g., zₙ, zₙ₊₁, zₙ₊₂, . . . , z_{T}).

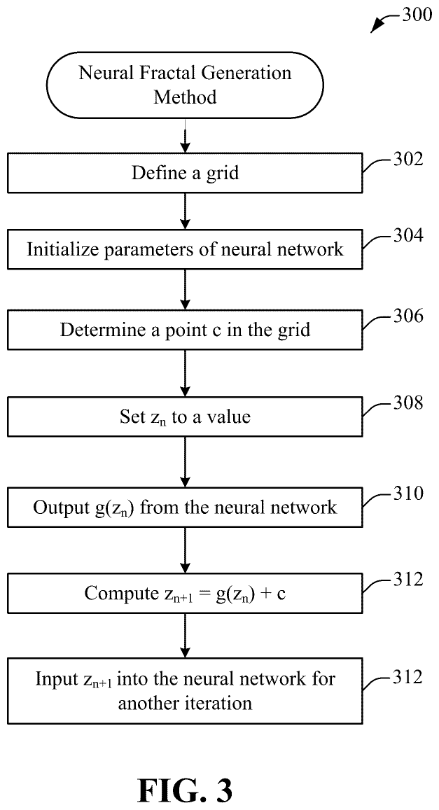

FIG. 3 depicts a flowchart 300 of a method for neural fractal generation according to some embodiments. The following describes the recursive iteration for a coordinate point. Multiple iterations of the recurrence relation may be performed for each coordinate point.

At 302, the process begins with defining a grid that will be used to generate the neural fractal image. This grid is a two-dimensional array of points that will be used to sample the complex plane and determine values c for the point. The grid size and resolution can be adjusted to control the level of detail in the final image. In some embodiments, a grid may include multiple grid cells where each cell corresponds to a pixel of the image. The points that are sampled may be within x, y coordinates in the pixel. There may be multiple coordinates to sample within a grid cell or pixel.

At 304, the parameters of the neural network are initialized. This includes setting the weights of the network. The weights may be randomly set, such as using a random number, or set using an algorithm. Different values for weights may result in a different function g being applied.

At 306, neural fractal generation system 104 selects a point c=x+y·j from the grid. The x and y values correspond to the coordinate values of the point on the grid. The output values of the neural network may be combined with this point to determine a new input for a next iteration in the recursive process.

At 308, neural fractal generation system 104 sets the input value zₙ to a value. For the first iteration, the value may be 0, but other values may be used. At 310, the output of the neural network g(zₙ) is computed for the value of zₙ. This involves passing the input through the network and applying the activation functions in nodes. The output of the network is a value based on the input and the weights of the neural network.

At 310, neural fractal generation system 104 calculates another input value zₙ₊₁=g(zₙ)+c. This combines (e.g., adds) the coordinate value to the output of the network to generate another input value for a next iteration.

At 312, the new input value is input into the neural network to generate another output in another iteration. The next value of z is determined using the relation g(zₙ)+c. A number of iterations T may be performed for a point. This results in a set of values z. Also, the above process may be performed for a number of sampled points on the grid.

Neural fractal generation system 104 may use the set of input values z to generate a synthetic image. A first process using a fractal set will be described, and then a second process using escape time coloring will be described. Other methods may also be appreciated.

### Fractal Set Coloring

The fractal set process samples points on the grid. Then, neural fractal generation system 104 categorizes points as being in a fractal set or not being in the fractal set. The points in the fractal set are used to determine pixel values for pixels. The pixel values are used to determine colors for the synthetic image. To determine whether a point c belongs to the fractal set, neural fractal generation system 104 iterates the recurrence relation for a fixed number of iterations T to obtain z_{T}(c). Points for which z_{T}(c) where |.| shows the norm of a complex number) remain bounded after T iterations belong to the (fractal set. Remaining bounded means that the value may meet the threshold, such as be less than a threshold. For example, the set of values |z| may be 0.14243, 0.23343, 0.3434, . . . , 0.5456. The value of 0.5456 may be the value z_{T}(c), which is the last value of the last iteration in the set of values. In some embodiments, neural fractal generation system 104 may add points to a fractal set that meet |z_{T}(c)|≤τ where τ is a threshold. The fractal set is used to generate the synthetic image. Points not in the fractal set are not used to generate the synthetic image. Neural fractal generation system 104 may generate a pixel value based on the proportion of points within the pixel that satisfy the condition. That is, a pixel may include multiple points of a grid in which pixel values were generated. In some embodiments, neural fractal generation system 104 rasterizes the final image by integrating over each pixel and computing the proportion of points within the pixel that satisfy the condition using:

$${\int }_{( x , y ) ϵ P}^{□} 1 \{ \vert {z}_{T} ( x + y \cdot j ) \vert \leq \} dxdy .$$

Neural fractal generation system 104 may use an estimation, such as a Monte Carlo estimation, to compute this integral. At the start of each epoch, neural fractal generation system 104 uniformly samples a subset of points {c₀, . . . , cₙ} from the grid and iteratively applies the recurrence relation of the neural network to obtain z_{T}(cᵢ)∀i for each point. The pixel value for a pixel is then determined by counting the number of points cᵢ within the pixel that satisfy the condition |z_{T}(cᵢ)|≤τ.

The above process may be inherently noisy, as different points landing in a pixel can have different locations and values. To mitigate this noise, neural fractal generation system 104 repeats the rendering process over several epochs, allowing each pixel to converge to its final value. After completing all epochs, neural fractal generation system 104 determines the pixel value, such as the intensity of each pixel, by combining, such as averaging, the results across all epochs. This procedure produces a grayscale image, which can then colorized, such as using pseudo-coloring. For example, the pixel values (e.g., intensities) may be mapped to colors using a color map that maps colors to pixel intensities. Different pixel intensities may be mapped to different colors. In some embodiments, the color for a pixel intensity may also be randomly selected. Pixels with the same pixel intensity may have the same color, and pixels with different pixel intensities may have different colors.

Each random initialization of the network weights results in a unique and complex recurrence relation, rendering a completely unique synthetic image. The use of neural fractals offers several advantages, including the ability to generate practically infinite, diverse fractal patterns without being limited by the zoom location or level. In some embodiments, neural fractal generation system 104 uses a fully connected neural network with six hidden layers of three neurons each, with complex weights drawn from a normal distribution. The network may use an activation function, such as a tanh activation, and the output may be raised to the third power, but other activation functions may be used and the output may be adjusted differently. This approach enables neural fractal generation system 104 to generate high-quality fractal images with unique patterns and structures, which can be used for various applications such as image synthesis, data augmentation, and representation learning.

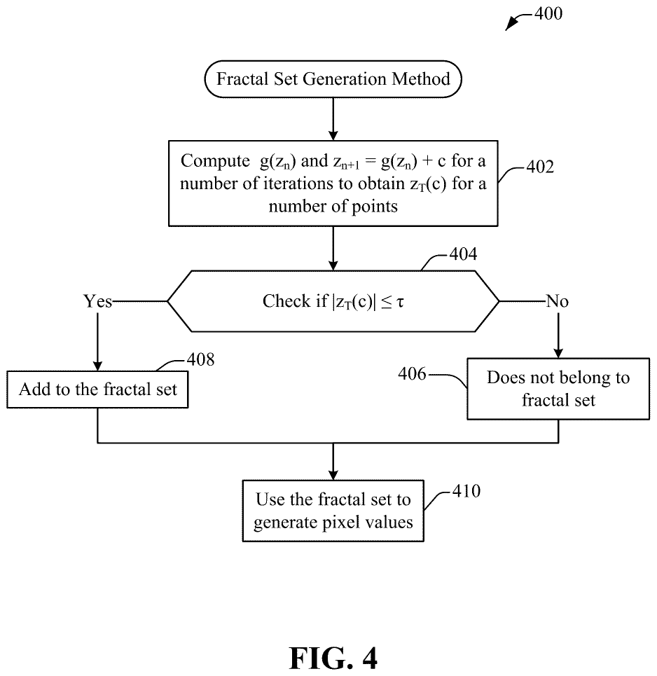

A point may be added to the fractal set based on a condition, such as when a threshold τ is met. FIG. 4 depicts a flowchart 400 of a method for adding points to a fractal set according to some embodiments.

At 402, neural fractal generation system 104 computes g(zₙ) and zₙ₊₁=g(zₙ)+c for a number of iterations to obtain z_{T}(c). The value of z_{T}(c) may be a single value that represents the result of iterating the recurrence relation T times, starting from the initial value z₀=0. The value z_{T}(c) may be determined for a number of points on the grid.

At 404, neural fractal generation system 104 determines whether z_{T}(c) meets a condition, such as |z_{T}(c)|≤τ for the points. For example, a value of 0.6743 for the point is compared to a threshold of 0.8. At 406, if value for a point does not meet the threshold, then the point is not added to the fractal set. At 408, if value for a point does meet the threshold, then the point is added to the fractal set. In the above example, 0.6743 is less than the threshold of 0.8, and the point is added to the fractal set. If the value of z_{T}(c) was greater than the threshold, the point would not be added to the fractal set.

At 410, at the end of the epoch, the points in the fractal set are then used to determine the pixel values for the image. For example, neural fractal generation system 104 counts the number of points within each pixel that met the threshold. Neural fractal generation system 104 determines the pixel value based on the count. If the pixel value is pixel intensity, a higher count may be a higher pixel intensity. The process is performed for multiple epochs. Then, after multiple epochs, neural fractal generation system 104 determines the final pixel intensity by combining the pixel intensities for the epochs, such as by averaging the pixel intensities. This procedure produces a grayscale image, which is then colorized using pseudo-coloring. The pixel values (e.g., intensities) may be mapped to colors using a color map.

The selection of the threshold value τ ensures the fractal image exhibits intricate structure and visual richness. If τ is too small, the image becomes entirely black, as most points are mapped to the black color. On the other hand, if τ is too large, the image becomes entirely white, as most points are mapped to the white color. Further complicating the process is that the optimal value depends on the specific neural network g used to generate the fractal. To find the optimal value of τ, an automatic adjustment process may be employed. The process may perform one rendering of an image to obtain values |z|. The process starts with a small initial value of τ and iteratively increases it by a factor, such as 1.1, until a threshold is met. For example, if at least 40% of the rendered values |z| fall below the threshold, the value of τ is frozen and the rest of the fractal generation process uses this value of τ. This ensures that the distribution of values is well-balanced, preserving the structural detail of the fractal.

In some embodiments, neural fractal generation system 104 may use escape time coloring instead of the process described above using the fractal set.

### Escape Time Coloring

Neural fractal generation system 104 may keep track of an escape count, which may be the number of iterations required for each sampled point to escape (e.g., does not meet) a threshold τ. This process assigns a same pixel value to all points with the same escape count. In this case, the pixel value may be a same color. The coloring scheme works by sampling a color (e.g., randomly) from a color map and assigning it to all points that escape at the same iteration. If there is a one-to-one mapping between points and pixels, the corresponding pixels also receive the same color.

The process may generate values z as described above in FIG. 2 for sampled points on the grid. As the process iterates, once a point escapes the threshold, the corresponding pixel has its pixel color frozen in place, and subsequent iterations focus on coloring the remaining pixels of the grid. This process continues until all pixels in the grid have been assigned a color. Multiple epochs may be performed to create multiple images, but a single epoch may be used. To create a final image, neural fractal generation system 104 combines the images, such as averages the images across all epochs, effectively combining the information from each epoch to produce a richly detailed and colored representation of the neural fractal image.

The sampling of points on the grid may use different processes. Neural fractal generation system 104 may use an adaptive sampling technique inspired by Monte Carlo rendering. The naive approach of uniformly sampling points across the entire image plane requires a large number of epochs to remove noise and achieve a high-quality fractal. In contrast, the adaptive sampling process allocates samples nonuniformly across the grid in epochs according to the rendering difficulty of each pixel, reducing computational costs and accelerating rendering.

In the first epoch, neural fractal generation system 104 distributes a few samples uniformly per pixel and render their corresponding color. Neural fractal generation system 104 then calculates the variance of these rendered colors for each pixel. This information is used to create an estimated variance map, which serves as a guide for adaptive sampling. The resulting variance map is smoothed using a filter, such as a box filter, with a kernel size, such as a size of 5. The smoothed map is normalized, and used as a sampling map to allocate samples in the next epoch.

After each epoch, neural fractal generation system 104 updates the variance map and adjusts the sampling distribution accordingly. Adaptive sampling can increase rendering speed and produce visually noiseless images. Certain pixels may converge more quickly and require fewer samples. The adaptive sampling algorithm reduces sample density in areas with low variance, allowing for faster rendering.

To further optimize the process, neural fractal generation system 104 adds a stopping criterion to prevent distributing samples to a pixel if its estimated variance is below a certain threshold. This ensures that computational resources are focused on areas that require more attention, without compromising image content. The adaptive sampling algorithm accelerates the rendering process without altering the image content, making it an effective solution for generating high-quality neural fractals efficiently.

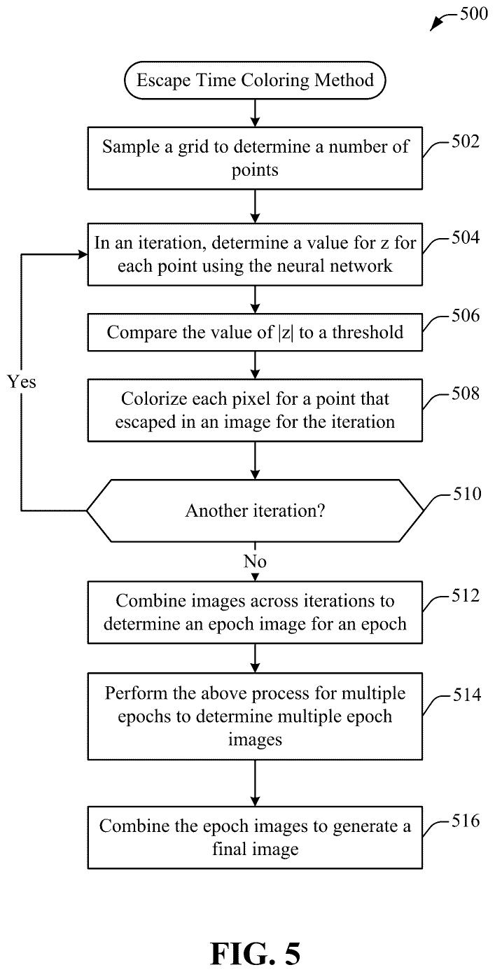

FIG. 5 depicts a flowchart 500 for generating neural fractals using escape time coloring and adaptive sampling according to some embodiments. At 502, neural fractal generation system 104 samples a grid to determine a number of points. Adaptive sampling may be used to sample a set of points for iterations in this epoch. Multiple epochs may be performed, which generate an epoch image for each epoch.

At 504, in an iteration, neural fractal generation system 104 determines a value for z for each point using the neural network. At 506, neural fractal generation system 104 compares the value of |z| for each point to the threshold to determine which points escaped. For example, after initialing the value of z to 0, for a first iteration of a point, the network generates g(zₙ). Neural fractal generation system 104 determines the value of zₙ₊₁=g(zₙ)+c. This value zₙ₊₁ is compared to the threshold to determine if the point meets the threshold. If not, the new value of zₙ₊₁ is input into the network to generate g(zₙ₊₁) after a second iteration. The new value of z is zₙ₊₂=g(zₙ₊₁)+c is compared to the threshold. This process continues until the threshold or a maximum number of iterations is met.

At 508, neural fractal generation system 104 colorizes each pixel in an image that corresponds to a point that escaped for the iteration. This step involves assigning colors to pixels based on whether their corresponding points have escaped or not. The color that is assigned may be based on the iteration number in which a pixel escaped. For example, the same color value is assigned to all pixels that escaped in the same iteration. The color value may be randomly selected or assigned via a rule.

At 510, neural fractal generation system 104 determines if another iteration should be performed. The number of iterations may be set to a value, such as 100. Also, the process may end if all pixels have escaped and been assigned a color. If another iteration is to be performed, the process reiterates to 504, where another iteration is performed to determine values for the points that were sampled using the new value of z as input.

When the iterations are finished, at 512, neural fractal generation system 104 combines images across iterations to determine an epoch image for an epoch. Each iteration may be associated with an image of pixels with colors. The images may be combined into the epoch image. The combination may assign the escape time color to the respective pixels in the epoch image. That is, a pixel will eventually be assigned a color in one of the iterations. That color is included in the epoch image.

At 514, neural fractal generation system 104 performs the above process for multiple epochs to determine multiple epoch images. The sampling of the grid may be performed adaptively for epochs as described above. This results in multiple epoch images.

At 516, neural fractal generation system 104 combines the epoch images across epochs to generate a final image. In some embodiments, neural fractal generation system 104 averages the pixel values from the epoch images. Using multiple epochs reduces noise and allows pixels to converge to a final value over multiple epochs.

### Neural Fractal Reverse-Stylization

Neural fractal reverse stylization is used to bridge the performance gap between models trained on synthetic data and those trained on real-world datasets. Synthetic data often lacks realistic textures and accurate color distribution, resulting in a domain gap. To address this issue, neural fractal generation system 104 employs neural style transfer, which is applied in a reverse process. That is, instead of combining the contents of a photograph with the style of an artwork, neural fractal generation system 104 runs the process in reverse, transferring the visual features of real images to synthetic ones. By utilizing a small dataset of real-world, license-free images from and applying a texture-based neural style transfer process, neural fractal generation system 104 generates stylized synthetic datasets that more closely resemble real-world data. One shortcoming of synthetic data is the lack of realistic textures and an inaccurate color distribution, which may contribute to a performance gap. The use of reverse stylization may reduce the domain gap.

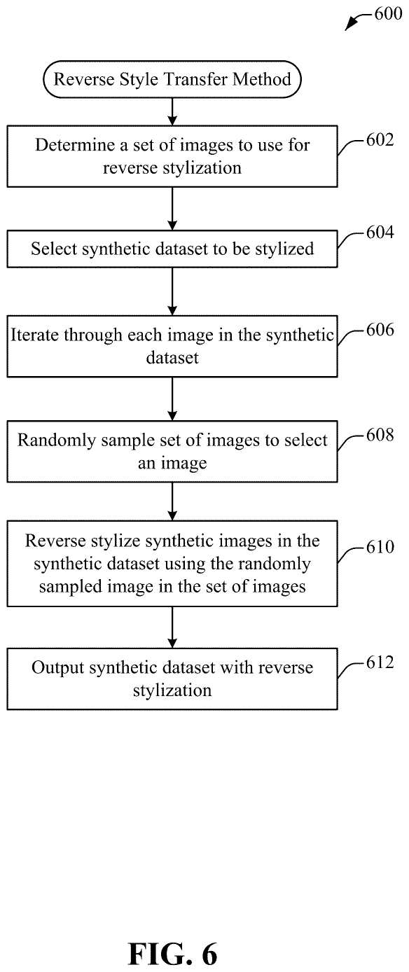

FIG. 6 depicts a flowchart 600 of a method for performing reverse stylization according to some embodiments. At 602, the neural fractal generation system 104 determines a set of images to use for reverse stylization. These images may be a collection of real-world images that will serve as the basis for transferring visual features to synthetic datasets. Neural fractal generation system 104 may select images that are diverse and representative of various styles, textures, and patterns found in real-world data, aiming to capture a wide range of characteristics.

At 604, neural fractal generation system 104 selects a synthetic dataset to be stylized, which may be a neural fractal dataset generated as described above or any other type of synthetic dataset that requires enhancement through reverse stylization.

At 606, neural fractal generation system 104 iterates through each image in the selected synthetic dataset, processing them one by one. At 608, for each synthetic image, neural fractal generation system 104 randomly samples a real image from the determined set to serve as the style reference for reverse stylization, introducing variability into the process and ensuring that the stylized synthetic images capture a wide range of styles and textures.

At 610, neural fractal generation system 104 applies a stylization process to each synthetic image in the dataset, using the randomly sampled real image as the style guide. Different processes to apply reverse stylization may be used. For example, texture from the real image may be applied to the synthetic image to transfer some visual features of the real image to the synthetic image. In some embodiments, neural fractal generation system 104 may use different processes to perform the reverse stylization. In some embodiments, a network may be used that is trained to reverse stylize synthetic images with real-world images. The network may include a model that is trained to extract visual features of the real-world images and apply the features to the synthetic images. In one instance, the reverse stylization may use a neural network to extract high-level stylistic features from a real image. It may then employ an optimization technique to modify the synthetic image, aiming to minimize the difference between its extracted features and those of the real image. This process may repeated until the features align closely. At a high level, stylization can be expressed as f(I, J), where f is the stylization method and I is a content image and J is a style image. In reverse stylization, I is a fractal image, and J is a natural image without necessarily a particular style. The reverse stylization method f results in content features from J being transferred to the fractal image I.

At 612, after reverse stylizing each synthetic image, neural fractal generation system 104 outputs a new synthetic dataset with reverse stylization applied. Neural fractal generation system 104 generates this dataset by transforming the original synthetic images to exhibit more realistic textures, colors, and patterns, making them more similar to real-world datasets. The resulting dataset is then available for use in training machine learning models, potentially improving their performance on tasks involving real-world data.

Neural fractal generation system 104 repeats the stylization process for each image in the synthetic dataset. Neural fractal generation system 104 generates a comprehensive and consistent stylized synthetic dataset that can effectively bridge the domain gap between synthetic and real-world data.

### Conclusion

Neural fractal generation system 104 generates synthetic datasets using neural fractals, which are derived from dynamical systems using complex-valued neural networks. The synthetic datasets may be used for training models, such as deep learning-based computer vision models. In an improvement, neural fractal generation system 104 uses adaptive sampling and escape time coloring. Also, to further bridge the domain gap between synthetic and real-world data, neural fractal generation system 104 uses reverse stylization of the synthetic datasets using a small sample of real images. This process not only reduces the domain gap but also adds meaningful features to the synthetic data, resulting in improved training of models.

The combination of neural fractal generation with reverse stylization creates high-quality synthetic datasets that can effectively train deep learning models, ultimately leading to improved performance on real-world computer vision tasks. For example, the use of neural fractals improves the performance of model training compared to other synthetic datasets. Also, reverse stylization reduces reconstruction loss, improves generated images, or improves accuracy in models compared to non-stylized datasets.

### System

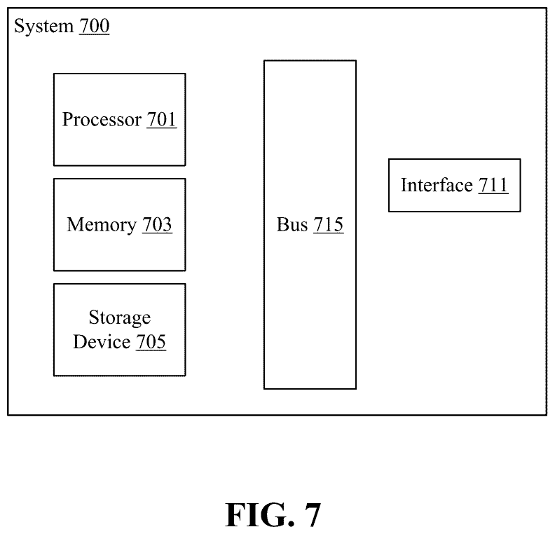

FIG. 7 illustrates one example of a computing device according to some embodiments. According to various embodiments, a system 700 suitable for implementing embodiments described herein includes a processor 701, a memory 703, a storage device 705, an interface 711, and a bus 715 (e.g., a PCI bus or other interconnection fabric.) System 700 may operate as a variety of devices such as neural fractal generation system 104, or any other device or service described herein. Although a particular configuration is described, a variety of alternative configurations are possible. Processor 701 may perform operations such as those described herein. Instructions for performing such operations may be embodied in memory 703, on one or more non-transitory computer readable media, or on some other storage device. Various specially configured devices can also be used in place of or in addition to processor 701. Memory 703 may be random access memory (RAM) or other dynamic storage devices. Storage device 705 may include a non-transitory computer-readable storage medium holding information, instructions, or some combination thereof, for example instructions that when executed by the processor 701, cause processor 701 to be configured or operable to perform one or more operations of a method as described herein. Bus 715 or other communication components may support communication of information within system 700. The interface 711 may be connected to bus 715 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
initializing parameters of a network;
sampling a plurality of points on a grid, wherein the grid corresponds to a plurality of pixels;
for a set of iterations for each point in the plurality of points:
inputting an input value for a point in the plurality of points into the network to determine an output value based on the parameters of the network;
computing a next input value for the point based on an output of the network and a position of the point in the grid;
recursively inputting next input values for the point into the network to generate a set of input values; and
comparing input values in the set of input values for the point to a threshold to determine a comparison result; and
using the comparison result for the plurality of points to determine pixel values for pixels in the plurality of pixels, wherein the pixel values are used to generate a synthetic image.

2. The method of claim 1, wherein:
the network comprises a neural network, and
the parameters of the neural network are generated randomly.

3. The method of claim 1, wherein the position of points in the plurality of points is based on an x and y coordinate in the grid.

4. The method of claim 1, wherein sampling the plurality of points on the grid comprises adaptively sampling the points, wherein points are non-uniformly selected based on a variance of colors for the pixels over multiple generations of synthetic images.

5. The method of claim 1, wherein the next input value z_{n+1} is equal to g(z_n )+c, wherein c is based on the position of the respective point in the grid and g(z_n) is the output value.

6. The method of claim 1, wherein comparing input values in the set of input values for the point to the threshold to determine the comparison result comprises:
determining a color for any points that meet the threshold in an iteration.

7. The method of claim 6, wherein determining the color for any points that meet the threshold comprises:
assigning a same color to any points that meet the threshold in a same iteration.

8. The method of claim 7, wherein other points that meet the threshold in another iteration are assigned another color.

9. The method of claim 8, wherein recursively inputting the next input values for the point into the network to generate the set of input values comprises:
inputting the next input value into the network for points that do not have an assigned color.

10. The method of claim 8, further comprising:
determining a first image based on colors that are assigned to pixels in the plurality of pixels over the set of iterations.

11. The method of claim 10, further comprising:
generating a plurality of first images for a plurality of epochs, wherein the plurality of first images are generated based on sampling a different plurality of points on the grid for each epoch in the plurality of epochs and performing the set of iterations for each point in the different plurality of points; and
combining the plurality of first images to determine the synthetic image.

12. The method of claim 1, further comprising:
determining a real-world image; and
transferring visual features from the real-world image to the synthetic image.

13. The method of claim 12, wherein the visual features are combined with a style of the synthetic image.

14. The method of claim 1, wherein comparing input values in the set of input values for the point to a threshold to determine the comparison result comprises:
adding the point to a final set as the comparison result when a final output value meets the threshold; and
not adding the point to a final set as the comparison result when a final output value does not meet the threshold.

15. The method of claim 14, wherein using the comparison result for the plurality of points to determine pixel values for pixels comprises:
counting a number of points in the final set that are within pixels in the plurality of pixels;
assigning the pixel value based on the number of points assigned to respective pixels; and
using the pixel value for respective pixels to determine a color for the pixels, wherein different pixels values are mapped different colors.

16. A non-transitory computer-readable storage medium having stored thereon computer executable instructions, which when executed by a computing device, cause the computing device to be operable for:
initializing parameters of a network;
sampling a plurality of points on a grid, wherein the grid corresponds to a plurality of pixels;
for a set of iterations for each point in the plurality of points:
inputting an input value for a point in the plurality of points into the network to determine an output value based on the parameters of the network;
computing a next input value for the point based on an output of the network and a position of the point in the grid;
recursively inputting next input values for the point into the network to generate a set of input values; and
comparing input values in the set of input values for the point to a threshold to determine a comparison result; and
using the comparison result for the plurality of points to determine pixel values for pixels in the plurality of pixels, wherein the pixel values are used to generate a synthetic image.

17. A method comprising:
initializing parameters of a network;
sampling a plurality of points on a grid, wherein the grid corresponds to a plurality of pixels;
for a set of iterations for each point in the plurality of points:
inputting an input value for a point in the plurality of points into the network to determine an output value based on the parameters of the network;
computing a next input value for the point based on an output of the network and a position of the point in the grid;
comparing the next input value for points in the set of points to a threshold;
determining a color for any points that meet the threshold; and
recursively inputting next input values for the point into the network until the pixels in the plurality of pixels are assigned a color to form a first image; and
using the first image to determine a synthetic image.

18. The method of claim 17, further comprising:
generating a plurality of first images for a plurality of epochs; and
combining the plurality of first images to determine the synthetic image.

19. The method of claim 17, wherein determining the color for any points that meet the threshold comprises:
assigning a same color to the any points that meet the threshold in a same iteration.

20. The method of claim 17, further comprising:
determining a first image based on the colors that are assigned to pixels in the plurality of pixels over the set of iterations;
generating a plurality of first images for a plurality of epochs, wherein the plurality of first images are generated based on sampling a different plurality of points on the grid for each epoch in the plurality of epochs and performing the set of iterations for each point in the different plurality of points; and
combining the plurality of first images to determine the synthetic image.
